(19) United States
(12) Patent Application Publication
(10) Pub. No.: US 2024/0025622 A1
(43) Pub. Date: Jan. 25, 2024

(54) ADVANCED MONO-MATERIAL EXPANDABLE POLYLACTIC ACID-BASED THERMAL AND PROTECTIVE PACKAGING AND METHODS THEREOF

(71) Applicant: Lifoam Industries, LLC, Greer, SC (US)

(72) Inventors: Saumitra Bhargava, Clarksville, MD (US); Jonathan Godfrey, Joppa, MD (US)

(21) Appl. No.: 18/356,617

(22) Filed: Jul. 21, 2023

Related U.S. Application Data
(60) Provisional application No. 63/369,005, filed on Jul. 21, 2022.
(60) Provisional application No. 63/482,136, filed on Jan. 30, 2023.

(51) Int. Cl. B65D 81/38; C08J 9/236

(52) U.S. Cl. CPC B65D 81/3816; B65D 81/389; B65D 81/3851; C08J 9/236; C08J 2367/04

(57) ABSTRACT

Molded foam articles are provided. The molded foam articles have at least one surface having at least a portion that has been skin-formed for improving the thermal and mechanical properties of the molded foam articles without the need for material, density, or foam particle size changes.

### CROSS-REFERENCE TO RELATED APPLICATIONS

This application claims priority to U.S. Provisional Patent Application No. 63/369,005, filed Jul. 21, 2022, and U.S. Provisional Patent Application No. 63/482,136, filed Jan. 30, 2023, both of which are incorporated herein by reference.

### FIELD OF THE DISCLOSURE

This disclosure relates generally to molded foam articles and, in particular, relates to molded foam articles formed entirely from a single material.

### BACKGROUND

Molded foam articles are used in a variety of diverse industries including thermal insulation and protective packaging, construction, infrastructure support, foodservice, and consumer products such as surfboards. Molded foam articles are commonly produced from expandable polystyrene (EPS), which has a well-known manufacturing process. However, EPS-based foam articles suffer from a variety of drawbacks that require compensating the properties of the EPS-based foam articles so that they may successfully be used for their desired purpose.

Consumer-facing foam articles such as insulated shippers are commonly used for shipping meal kits, confectionary products, cakes, other perishable goods, and pharmaceutical items such as vaccines. The overall retail market in the United States was around $4.3 trillion in 2021, with ecommerce accounting for around $1 trillion. In 2022, sales from Amazon alone exceeded in-store sales from Wal-Mart, with over 11.5% of Wal-Mart's own sales occurring online. The vast majority of product packaging used to pack and ship fragile or perishable products purchased online are EPS-based insulated shippers typically enclosed in a corrugated cardboard box because direct application of tapes and other adhesives on the EPS-based shipper lose efficacy after a short period of time. Alternatively, some insulated EPS shippers are held together with straps or a shrink sleeve. However, both of these methods involve using a different material to keep the shipper lid secured to the base.

Alternatives to EPS-based shippers have taken the form of molded pulp packaging which, although recyclable on their own, still require additional components such as an outer corrugate layer, tape, or labels. Another alternative is thermoformed polyethylene terephthalate (PET), which again requires an additional component such as corrugate if used to ship impact-sensitive commodities. Another alternative uses inflatable air protectors using polyethylene film, but these inflatable protectors must be enclosed in corrugate to protect the integrity of the inflated protectors. Yet another alternative shipper takes the form of a wooden crate with packaging such as straw or paper strips, most commonly seen for shipping wine bottles. One attempt to homogenize the materials in a shipper takes the form of a corrugate-only shipper, but this solution sacrifices the thermal and impact protection characteristic of expandable foam packaging. Recycling each of these shippers requires additional effort and cost associated with separating the disparate components.

Previous attempts to mitigate the additional costs and drawbacks associated with material mismatch involve corrugated cardboard with paper-based tape and labels. However, the cost associated with tape, glue, varnish, and heavy printing on the corrugate result in increased levels of solid waste, wasted energy, and chemical use to clean corrugate for reuse. Furthermore, corrugated cardboard alone offers poor impact and vibration protection that must be compensated for through the addition of more corrugate, increasing packaging size and weight.

Accordingly, improved molded foam articles are needed for overcoming one or more of the technical challenges described above.

### BRIEF DESCRIPTION OF THE DRAWINGS

The detailed description is set forth with reference to the accompanying drawings. The use of the same reference numerals may indicate similar to identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

The patent or application file contains at least one drawing executed in color. Copies of this patent or patent application publication with color drawing(s) will be provided by the Office upon request and payment of the necessary fee.

FIG. 1 is a side view of a two-piece container in accordance with the present disclosure.

FIG. 2A is a side view of a container having a living hinge in a closed configuration in accordance with the present disclosure.

FIG. 2B is a side view of the container in FIG. 2A in an open configuration in accordance with the present disclosure.

FIG. 2C is a side view of the container in FIGS. 2A and 2B in an open configuration in accordance with the present disclosure.

FIG. 2D is a side view of the container in FIGS. 2A-2C in a partially open configuration in accordance with the present disclosure.

FIG. 3A is a top view of a two-piece container in accordance with the present disclosure.

FIG. 3B is a perspective view of the container in FIG. 3A in accordance with the present disclosure.

FIG. 3C is a perspective view of the container in FIGS. 3A and 3B in accordance with the present disclosure.

FIG. 4A is a top view of a container having a “window” in accordance with the present disclosure.

FIG. 4B is a top view of the container in FIG. 4A in accordance with the present disclosure.

FIG. 4C is a side view of the container in FIGS. 4A and 4B in accordance with the present disclosure.

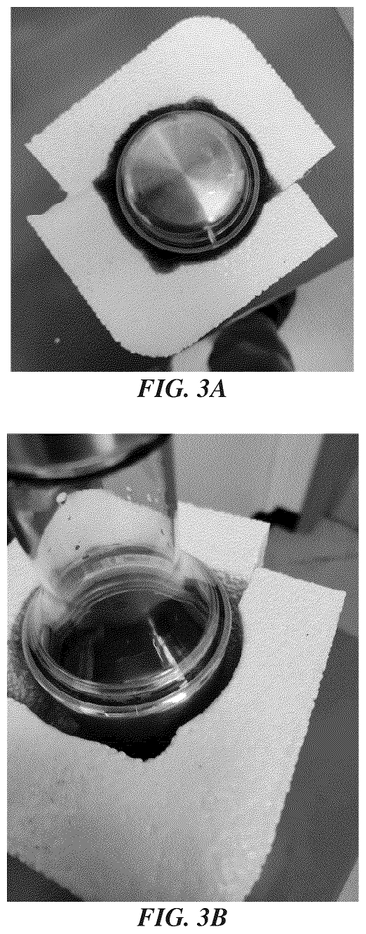

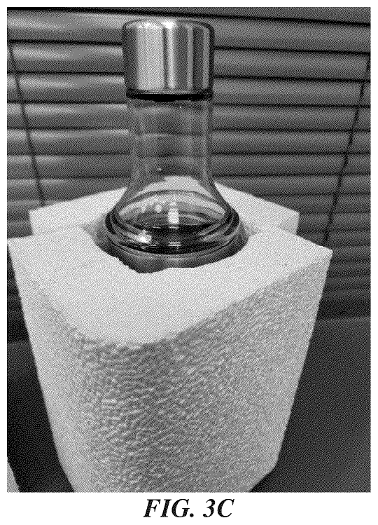

FIG. 3A is a perspective view of a molded bead foam article with a laminated film in accordance with the present disclosure.

FIG. 3B is a perspective view of a molded bead foam article with a laminated film in accordance with the present disclosure.

FIG. 3C is a side view of a molded bead foam article with a laminated film in accordance with the present disclosure.

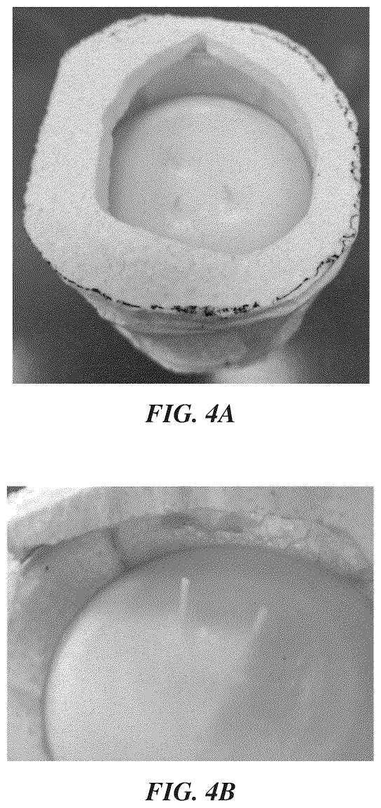

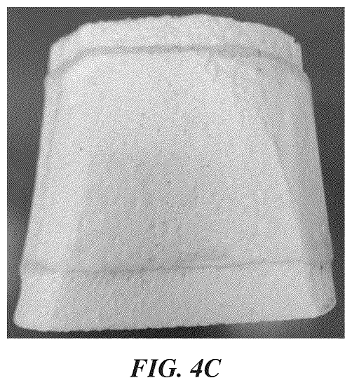

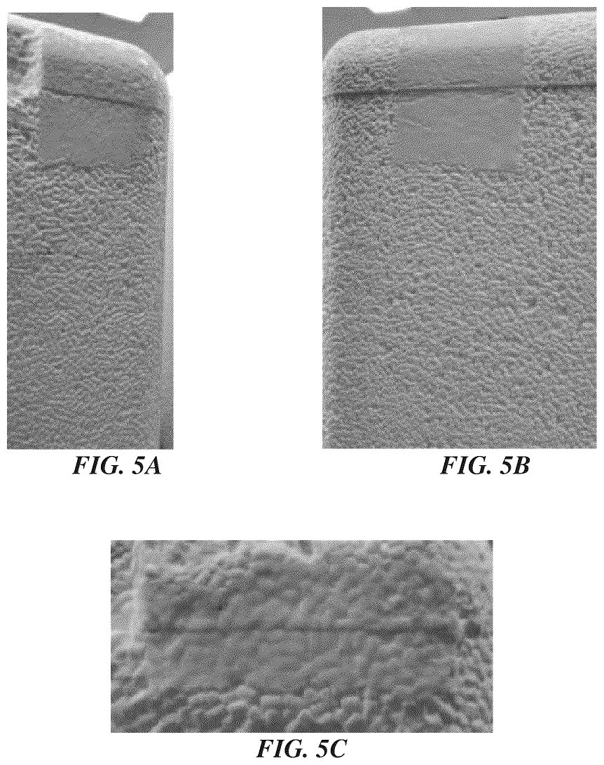

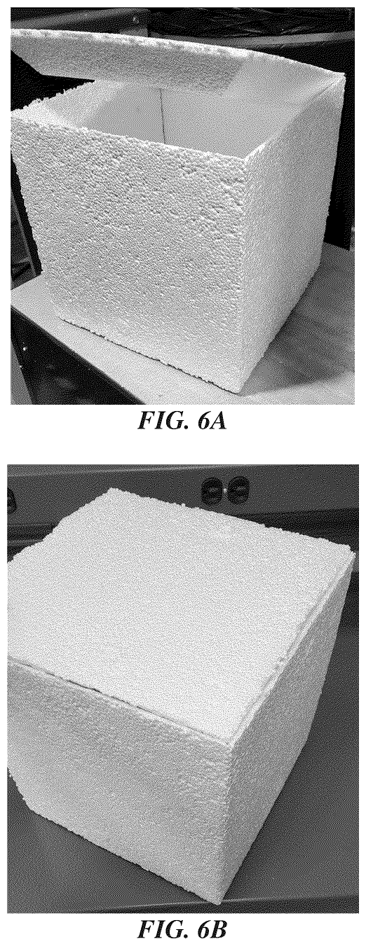

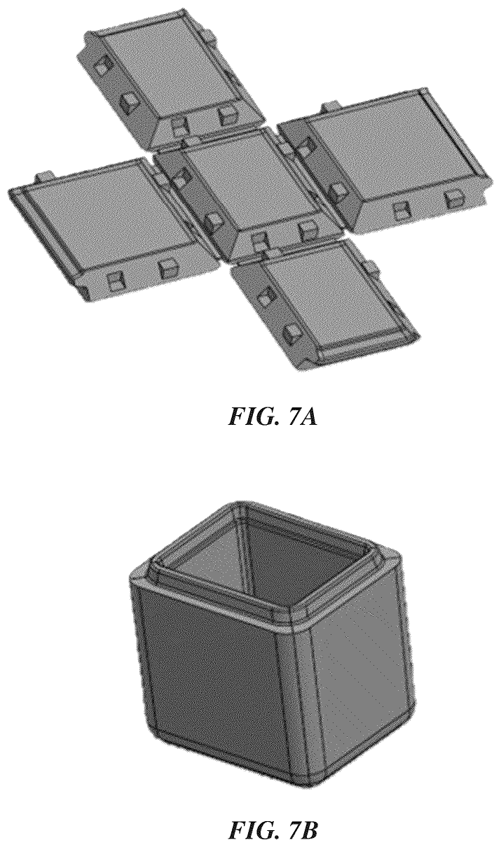

FIG. 4A is a perspective view of a molded bead foam article in accordance with the present disclosure.

FIG. 6B is a perspective view of a molded bead foam article in accordance with the present disclosure.

FIG. 7A is a perspective view of a five-sided fold-flat shipper in a flat configuration in accordance with the present disclosure.

FIG. 7B is a perspective view of a sealed five-sided fold-flat shipper in a folded configuration in accordance with the present disclosure.

### DETAILED DESCRIPTION

Containers such as thermal shippers and protective packaging are provided herein including molded foam articles formed from a single material, i.e., mono-material molded foam articles. In particular, it has been unexpectedly discovered that forming a container from two or more portions, each portion comprising a molded foam article consisting of polylactic acid-based molded bead foam, and joining the two or more portions together enables the formation of a container that consists entirely of a single material.

Throughout this disclosure, various aspects are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6, etc., as well as individual numbers within that range, for example, 1, 2, 3, 4, 5, and 6. This applies regardless of the breadth of the range.

As used herein, the term “about” with reference to dimensions refers to the dimension plus or minus 10%.

Containers

Containers are disclosed herein. In some embodiments, the containers comprise two or more portions configured to be joined together without the use of adhesive to form the container, each portion consisting of polylactic acid (PLA) molded bead foam. As used herein, “molded bead foam” refers to an article formed from a polymeric foam that has gone through an expansion and bead molding process. The article may be in the form of a two-dimensional panel or a three-dimensional structure such as a box. Other polymeric foams are capable of being expanded and molded in a way similar to expandable polystyrene, such as polypropylene, polyethylene, polyurethane and polylactic acid.

As used herein, a “container” refers to any enclosure into which a consume product may be placed for storage, shipping, and/or presentation to the consumer. For example, the container may be a thermal shipper for shipping thermally sensitive goods. In another example, the container takes the form of protective packaging for fragile or breakable goods.

In some embodiments, the container includes at least one interface between the at least two portions that is heat-sealed. In other words, the at least two surfaces are heated and pressed together such that the interface between the surfaces is sealed. In some embodiments, the heat-sealed interface operates as a tamper-evident seal. In some embodiments, the force necessary to remove the heat sealed interface, i.e., the force necessary to break the tamper-evident seal, can be adjusted by adjusting the cross-sectional area of adhesion and the force used to adhere the two portions. In some embodiments, the force required for separating the heat-sealed portions may be from about 5 lbf to about 50 lbf. In some embodiments, the force necessary to separate the heat-sealed portions is approximately equal to the force required to break or fracture one of the molded foam articles. It has been unexpectedly discovered that the heat-sealed interface may have an adhesion strength equal to a monolithic molded foam article. For example, the heat-sealed interface may require between about 5 to about 10 lbf to separate, representing a tamper-evident seal that can be removed by a consumer through application of reasonable manual force. As another example, the heat-sealed interface may require between about 40 to about 50 lbf to separate, which may require tools such as a knife to separate.

In some embodiments, the at least two portions are initially separate until joined together. For example, the at least two portions may each have a surface with a corresponding shape such that the at least two portions may be joined together by heating the surfaces and pressing them together. In some embodiments, the at least two portions are initially joined at a hinged interface such as a living hinge. For example, the at least two portions may be configured to “open” and “close” along the hinge to permit the insertion and/or removal of product(s) within the container such that the container takes the form of a “clamshell” container.

In some embodiments, the container includes at least one interface between the at least two portions, the interface sealed by a PLA-based film. PLA-based film to seal the edge or using hot film at the interface enables sealing without tape or additional structural components such as corrugated cardboard, shrink-film, or bands/straps. It has been unexpectedly discovered that PLA-based film readily adheres to the surface of PLA-based molded bead foam articles, enabling the formation of a mono-material package. In some embodiments, the PLA-based film operates as a tamper-evident seal for the container. In some embodiments, the PLA-based film is further printed with ink to enhance the ability to detect tampering. It has further been unexpectedly discovered that the adhesion of a PLA-based film to a surface of a PLA-based molded bead foam article can supplement defects in the molding process, such as localized imperfections or poor fusion between beads

In some embodiments, the effective temperature range for facilitating adhesion of the PLA-based film varies depending on the film thickness, crystallinity, draw, sticky point, and conductivity. Some PLA-based films experience adhesion best at one range of temperatures, such as between about 250° F. and 360° F., although the suitable ranges for temperatures vary with the dimensions of the PLA-based film and the PLA-based molded foam article. Depending on the properties of the PLA-based film, the molding process and film adhesion process may have a coincident optimal temperature range, such as between about 300° F. and 330° F., so that the molded bead foam article may be formed and simultaneously, or at least immediately subsequently, be adhered to or with a PLA-based film. As used herein, a “PLA-based film” refers to a film including PLA polymer blended with other degradable polymers such as PBS, PBAT, or PHA.

In some embodiments, when a surface of the molded bead foam article is heated by a heating element, the molded bead foam article is capable of adhering to a second molded bead foam article without the need for adhesives and without producing flammable gas. The heating element may be a clothing iron, heated plate or platen, a heat gun, low-pressure or saturated steam, or water. The heating element may have a temperature of between about 90° C. to about 115° C., such as between about 92° C. to about 108° C. When heating with water having a temperature of between about 92° C. to about 98° C., only between about 3 seconds to about 10 seconds of exposure is needed to sufficiently heat the surface of the PLA bead foam article. By using a heating element, such as a clothing iron, only the desired surface of the molded bead foam article is heated. It has been unexpectedly discovered that two heated surfaces of two molded foam articles formed from PLA may be joined and bonded with a strength comparable to a single molded foam article. Similar bonding has not proven possible with EPS, EPP, or EPE with household appliances such as hair dryer and clothes iron. Instead, hot air welding is necessary to join articles formed from EPP and EPE, which is a process operating at higher temperatures than those achievable with household appliances, necessitating the use of special controls and guards on hot air welding machines. Without intending to be bound by any particular theory, it is believed that PLA-based articles have a glass transition temperature (T_{g}), melting temperature (Tₘ), and degree of crystallinity that is favorable for producing the necessary tackiness upon heating at temperatures achievable with household appliances, steam, or hot water.

In some embodiments, the molded bead foam article is in the form of a shipper free of labels, tape, adhesive, or a phase-change material. As used herein, a “phase-change material” refers to a material designed to increase, decrease, or maintain the temperature of the interior and contents of a shipper. For example, a pack of ice included in a shipper to prolong the cool or frozen nature of cold contents, such as seafood, is a “phase-change material.” It has been unexpectedly discovered that a container formed exclusively from polylactic acid, when used as a shipper, has improved thermal performance and may be used without any phase-change material. Thus, a shipper as described herein may be loaded with thermally sensitive commodities and sealed with PLA-based film or using a heat seal, and then directly stored in a temperature-controlled warehouse until shipment without the need for phase-change material and without various detrimental effects common in conventional shippers, such as the risk of tape delamination or deterioration of corrugated cardboard. According to the Institute of Packaging Professionals, corrugate is known to deteriorate in compressive strength with time, especially at high relative humidity. After 90 days, corrugate boxes lose 45% of their compressive strength.

One exemplary application for the mono-material container described herein relates to gift snack boxes, such as mail-order gift chocolates. By packaging and refrigerating the chocolates or other snacks in PLA-based containers as described herein, the manufacturer can removed the container from the refrigerated storage and immediately ship the package to the consumer without repackaging the snacks and without the need to incorporate phase-change material.

In some embodiments, the molded bead foam article is in the form of a fold-flat shipper configured to fold into a container for shipping commodities. As used herein, a “fold-flat shipper” refers to a shipper that may be unfolded into a flat configuration. For example, a shipper in the form of a 6-sided box may be unfolded so that each of the 6 sides are flat, and each of the 6 sides is connected to at least one other side. In some embodiments, the boundary between two sides of a fold-flat shipper are joined to produce a self-standing box. The properties of a box made with fold flat “C”-shaped panels or individual panels is comparable to a molded box with similar dimensions. The fold-flat shipper occupies around 80% less volume during shipment and storage. Thus, fold-flat shippers may be assembled and sealed into a functioning box at either the distributor or the manufacturer.

In some embodiments, the molded bead foam article is in the form of a single panel configured to be inserted into a shipper for improving the thermal and mechanical properties of the shipper. For example, shippers as described herein may be produced in bulk, and those shippers intended to be shipped to warmer climates, or with commodities having a heightened thermal sensitivity, may be supplemented with an additional, stand-alone panel, thereby improving the thermal and mechanical properties of the bulk-produced shipper without the need for unique production lines or processes for those climates or commodities. The panel may be affixed to a base or other article using a hot surface such as a heated platen, hot air, hot water, or steam. Conventional molded foam containers with any single thicker sidewall or base is challenging to produce because of the different molding characteristics associated with varying thicknesses. Thus, simply adding a stand-alone panel enables wall thickness modification without new tooling, enhancing the ability for the container to maintain a desired or suitable temperature.

In some embodiments, the single panel is configured to be affixed to an external surface of the container, such as through the formation of a heat seal or using PLA-based film, as described herein. Such a heat sealed panel may advantageously enhance the thermal properties of the container without affecting the molding process used to form the container, and may further advantageously achieve this enhancement without changing the volume or dimensions of the container cavity.

Methods for Producing Molded Foam Articles

Methods for producing molded foam articles are also disclosed herein. In one aspect, the methods include producing a molded bead foam article as described above. In another aspect, the method includes molding a plurality of foam beads including polylactic acid to produce a molded foam article, and optionally joining the molded foam article with one or more additional molded foam articles formed from polylactic acid to produce a shipper formed exclusively from polylactic acid.

In some embodiments, the method is performed in-line. In other words, each step of forming the molded foam article is performed subsequently in approximately the same location. In some embodiments, the method is performed by automated apparatus. In other words, apparatus such as robotic instruments may perform each step necessary for forming the molded foam article, such as deliver the foam particles to the mold, mold the molded foam article, remove the molded foam article from the mold, adhere polylactic-based films, heat and join two or more molded foam articles, fold the molded foam article into a shipper, and the like.

The wine bottle example shows ability to add stand-off pieces to bottle packaging allowing bottles of different height to be shipped in a common box.

### EXAMPLES

The disclosure may be further understood with reference to the following non-limiting examples.

### Example 1: Mono-Material Wine Shippers

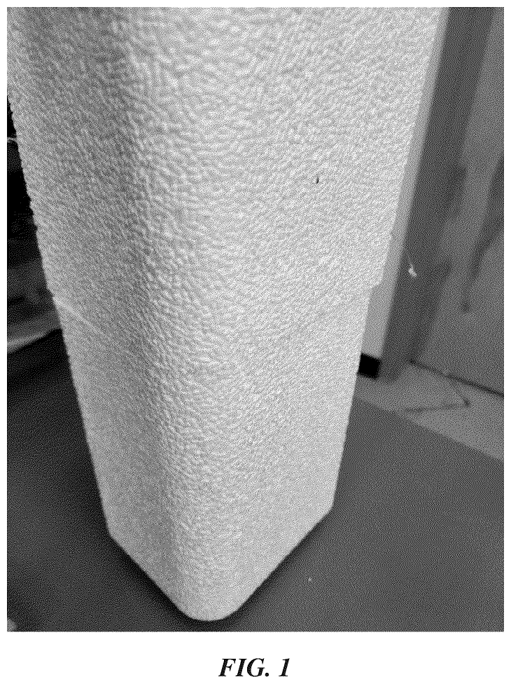

PLA-based molded foam articles were formed as described herein. Two articles were formed with a complementary shape, each article having a cavity such that, when the articles were placed against one another, a container is formed with a cavity that could accommodate a wine bottle. The container is depicted in FIG. 1. This container provided both thermal and mechanical protection for the wine bottle.

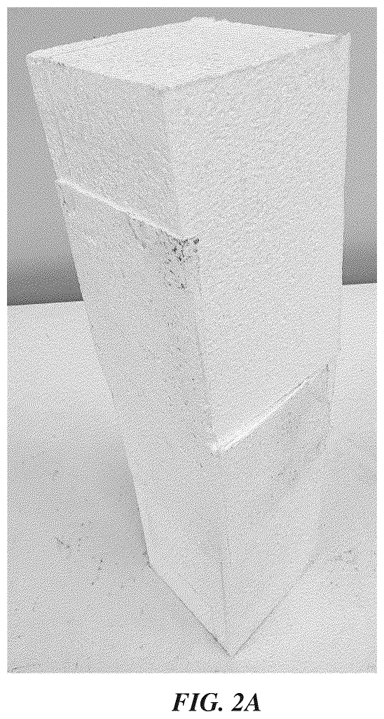

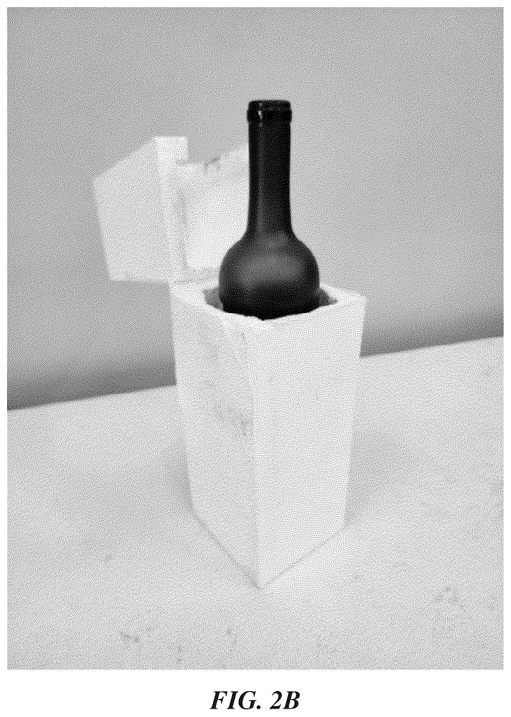

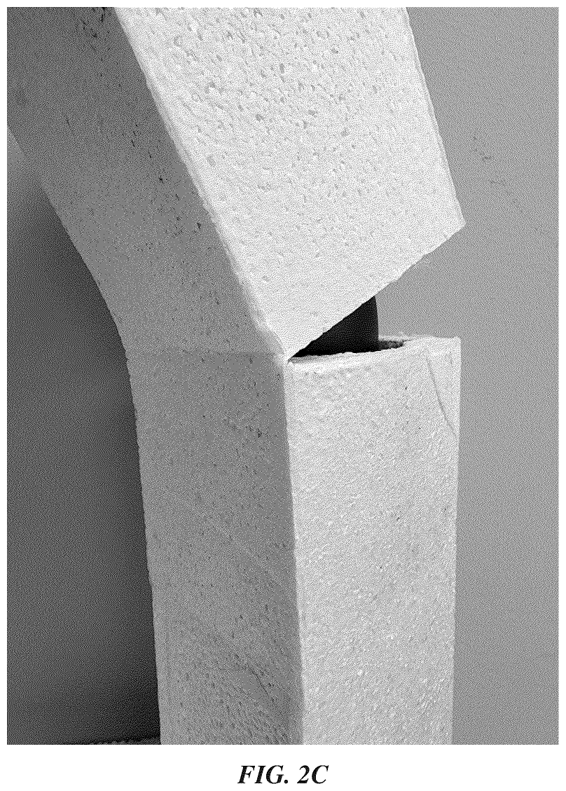

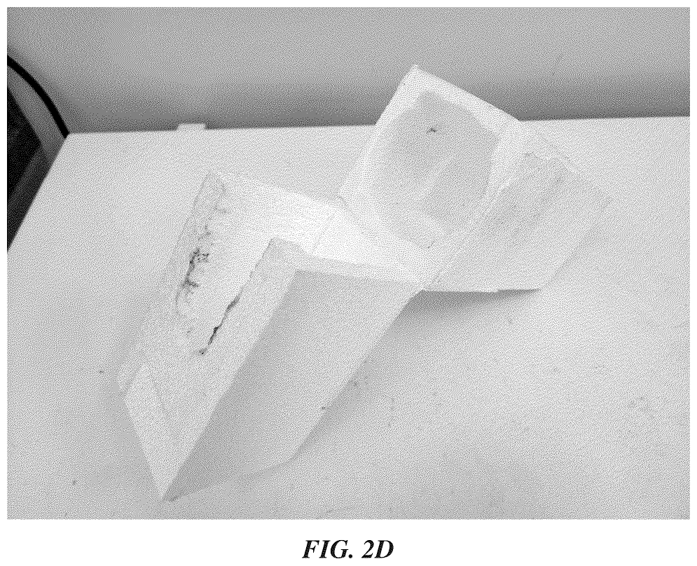

Another wine shipper was formed having a living hinge. When the wine bottle was loaded into the container, the contacting surfaces for each half of the container were heat-sealed to form the container. In this form, the container is ready to ship without the addition of corrugate. The container is depicted in FIGS. 2A-2D.

### Example 2: Mono-Material Container Having Complex Shape

PLA-based molded foam articles were formed as described herein. Two articles were formed configured to wrap around the perimeter of an irregularly shaped object. The contacting surfaces of each article were heated and pressed together to join the articles to form the container. The container is depicted in FIGS. 3A-3C. Although not depicted in FIGS. 3A-3C, a third molded foam article, or plurality of molded foam articles, may be added to the container in FIGS. 3A-3C to act as a lid or to otherwise fully enclose the commodity stored in the container.

### Example 3: Mono-Material Package with Product “Window”

PLA-based molded foam articles were formed as described herein. A first article was configured to enclose a candle, while a second article took the form of a ring with a void in the middle. A candle was positioned within the first article and the second article was adhered to the first using a heat-sealing process as described herein. The result is depicted in FIGS. 4A-4C. This container protected the candle and enabled smelling the candle's aroma.

### Example 4: Formation of Mono-Material Boxes

PLA-based molded foam articles were formed as described herein. One article was in the form of a 5-sided box with a corresponding lid. The shipper was loaded with a payload and phase-change material, and the lid was sealed with PLA-based film heated with a heat gun at 200° C. FIGS. 5A-5C depict the sealed PLA-based film, which also acted as a tamper-evident seal.

Two other articles were in the form of “C”-shaped panels which were folded and joined together to form a 6-sided box as depicted in FIGS. 6A-6B. The two “C”-shaped panels were joined at the interface through heat sealing. The lid seen in FIG. 6A may be unheated initially until the container is intended to be closed and sealed.

### Example 5: Fold-Flat Shippers

PLA-based molded bead foam articles were produced as described herein. The articles were in the form of “fold-flat” box shippers that are easily stacked and shipped in bulk, and are capable of being folded into a shipper. The flat configuration is depicted in FIG. 7A, and the folded configuration is depicted in FIG. 7B. Tabs such as those depicted in FIG. 7B may be heated with steam, hot water, or a heated surface such as a heated platen and inserted into the corresponding slot on an adjacent panel to lock the panels together in a particular configuration. The tabs and slots are molded during the bead foam molding process.

### Example 6: Thermal Performance Change with Supplemental Panel

PLA-based molded bead foam articles were produced as described herein. A control sample had dimensions of 8″×6″×8″ and was filled with 3 lbs of ice. A test sample had the same dimensions, but a 1″ thick piece of foam having a skinned surface was added to the bottom of the sample prior to adding the ice. The ice in the control took 36.3 hours for the ice to completely melt. The ice in the test sample took 40.1 hours for the ice to melt, representing an 11% improvement realized after simply adding a 1″ thick piece of foam.

While the disclosure has been described with reference to a number of embodiments, it will be understood by those skilled in the art that the disclosure is not limited to such embodiments. Rather, the disclosure can be modified to incorporate any number of variations, alterations, substitutions, or equivalent arrangements not described herein, but which are commensurate with the spirt and scope of the disclosure. Conditional language used herein, such as “can,” “could,” “might,” or “may,” unless specifically stated otherwise, or otherwise understood within the context as used, generally is intended to convey that certain embodiments include, while other embodiments do not include, certain features, elements or functional capabilities. Additionally, while various embodiments of the disclosure have been described, it is to be understood that aspects of the disclosure may include only some of the described embodiments. Accordingly, the disclosure it not to be seen as limited by the foregoing described, but is only limited by the scope of the appended claims.

That which is claimed is:

1. A container comprising:
at least two portions configured to be joined together without the use of adhesive to form the container, each portion consisting of polylactic acid-based molded bead foam.

2. The container of claim 1, further comprising at least one interface between the at least two portions, wherein the interface is heat-sealed.

3. The container of claim 2, wherein the heat-sealed interface comprises a tamper-evident seal.

4. The container of claim 1, further comprising at least one interface between the at least two portions, wherein the interface is sealed by a PLA-based film.

5. The container of claim 1, wherein the at least two portions are initially separate until joined together.

6. The container of claim 1, wherein the at least two portions are initially joined at a hinged interface.

7. The container of claim 1, wherein the container is configured to be composted without undergoing separation of any component part of the container.

8. The container of claim 1, further comprising at least one interface between the at least two portions, and a film comprising polylactic acid disposed on the interface.

9. The container of claim 3, wherein the container is in the form of a thermal shipper for shipping thermally sensitive commodities, and wherein the film is used to seal edges of a thermal shipper.

10. The container of claim 3, wherein a strength of adhesion between the at least two portions is configured to be adjustable based on a cross-section of adhesion between the at least two portions.

11. The container of claim 1, wherein the container is in the form of a box having a plurality of sides.

12. The container of claim 1, wherein the container is in the form of a shipper free of labels, tape, adhesive capable of being recycled or composted without removal of labels or additional packaging.

13. The container of claim 1, wherein the container is in the form of a fold-flat shipper configured to fold into a container for shipping commodities.

14. The container of claim 1, further comprising a panel configured to be inserted into the container or adhered to an external surface of the container, wherein the panel improves thermal and mechanical properties of the container, and wherein the panel consists of polylactic acid-based molded bead foam.

15. The container of claim 1, wherein at least one of the at least two portions comprises a molded bead foam article having a cavity through which a container contents may be viewed, touched, and smelled.

16. A method for producing a container comprising:
molding a plurality of foam beads consisting of polylactic acid in a mold to produce at least two portions configured to be joined together without the use of adhesive, and
forming the container by joining the at least two portions together.

17. The method of claim 16, wherein joining the at least two portions together comprises heat sealing at least one interface between the at least two portions.

18. The method of claim 16, wherein joining the at least two portions together comprises disposing a film comprising polylactic acid on at least one interface between the at least two portions.
